(19) United States
(12) Patent Application Publication
(10) Pub. No.: US 2026/0320358 A1
(43) Pub. Date: Oct. 15, 2026

(54) Method for Testing a Generative Language Model

(71) Applicant: Robert Bosch GmbH, Stuttgart (DE)

(72) Inventors: Matthias Woehrle, Bietigheim-Bissingen (DE); Jesko Hecking-Harbusch, Leonberg (DE); Martin Weiss, Haldensleben (DE)

(21) Appl. No.: 19/643,156

(22) Filed: Apr. 9, 2026

(30) Foreign Application Priority Data
Apr. 11, 2025 (DE) 10 2025 114 297.1

(51) Int. Cl. G06N 3/0475; G06N 3/08

(52) U.S. Cl. CPC G06N 3/0475; G06N 3/08

(57) ABSTRACT

A method for testing a generative language model includes, for at least one request to the generative language model, generating, for at least one augmentation, at least one augmented version of the request using the augmentation, and embedding the at least one augmented version of the request and the request into an embedding space using a machine embedding model. The method further includes determining, for the at least one augmentation, a request similarity measure between the at least one augmented version of the request and the request from a measure of similarity of the embedded at least one augmented version of the request to the embedded request in the embedding space. The method includes generating test data for the generative language model using the at least one augmentation, and testing the generative language model using the generated test data depending on the request similarity measure.

This application claims priority under 35 U.S.C. § 119 to patent application no. DE 10 2025 114 297.1, filed on Apr. 11, 2025 in Germany, the disclosure of which is incorporated herein by reference in its entirety.

The present disclosure relates to methods for testing a generative language model.

### BACKGROUND

Generative language models may be employed for various purposes, such as generating program code. However, a typical problem with using generative language models is the occurrence of hallucinations, where the language model generates false or irrelevant information. For example, in the case of program code generation, a generative language model may generate program code that is not compilable or fails to accomplish a particular task, e.g., controlling a robot, as desired. Generative language models should therefore be tested prior to use, particularly in an industrial environment, ideally with a focus on the use, for which they are intended. Effective approaches are desirable for this purpose.

### SUMMARY

According to various embodiments, a method for testing a generative language model is described, comprising, for at least one request to the generative language model, generating, for at least one augmentation, at least one augmented version of the request using the augmentation, embedding the at least one augmented version of the request and the request into an embedding space using a machine embedding model, determining, for the at least one augmentation, a request similarity measure between the at least one augmented version of the request and the request from a measure of similarity of the embedded at least one augmented version of the request to the embedded request in the embedding space, and generating test data for the generative language model using the at least one augmentation, and testing the generative language model using the generated test data depending on the request similarity measure.

The method described above enables an effective robustness assessment of a generative (black-box) language model by focusing on plausible augmentations. It can be performed multiple times for different requests and different augmentations, and the language model can be improved by selecting results (i.e., feedback to the language model). This allows the language model to be improved so that fewer hallucinations occur.

Various exemplary embodiments are specified in the following.

Exemplary embodiment 1 is a method for testing a generative language model, as described above.

Exemplary embodiment 2 is a method according to exemplary embodiment 1, comprising generating a plurality of augmented versions of the request using the at least one augmentation; generating, for each of the plurality of augmented versions of the request, at least one embedding of the augmented version of the request into the embedding space and generating an embedding of the request; determining an embedding similarity measure between the generated embeddings of the augmented versions of the request and the embedding of the request; and determining the request similarity measure by aggregating, preferably averaging, the embedding similarity measures across the augmented versions of the request.

Aggregating, e.g., averaging, across multiple augmented versions of the same request increases the informativeness of the request similarity measure regarding the plausibility of the respective augmentation.

According to one embodiment, the method comprises: generating, for each augmented version of the request, multiple embeddings of the augmented version of the request in the embedding space using the embedding model; determining, for each embedding of an augmented version of the request, an embedding similarity measure as a measure of the similarity of the embedded augmented version of the request to the embedded request in the embedding space; and determining the request similarity measure by averaging the embedding similarity measures across the embeddings of the augmented version of the request.

Averaging the measures of the similarity of the embedded at least one augmented version of the request to the embedded request in the embedding space (i.e., the embedding similarity measures) across the embeddings further increases the informativeness of the request similarity measure regarding the plausibility of the augmentation. For example, the different embeddings of the same augmented version may be generated using multiple seeds for the embedding model.

Exemplary embodiment 3 is a method according to exemplary embodiment 1 or 2, comprising generating test data for the generative language model using the at least one augmentation and testing the generative language model using the generated test data in response to the request similarity measure exceeding a specified threshold.

This focuses testing on augmentations with a certain minimum plausibility.

Exemplary embodiment 4 is a method according to one of exemplary embodiments 1 to 3, comprising generating, for each of a plurality of augmentations, at least one augmented version of the request using the augmentation;
embedding the at least one augmented version of the request and the request into an embedding space using the machine embedding model;
determining, for the augmentation, a request similarity measure between the at least one augmented version of the request and the request from a measure of similarity of the embedded at least one augmented version of the request to the embedded request in the embedding space;
selecting, from the plurality of augmentations, one or more augmentations, for which the highest request similarity measures have been determined and generating test data for the generative language model using the at least one selected augmentation and testing the generative language model using the generated test data.

Thus, the generative language model is tested using test data obtained by one or more augmentations having the highest plausibility.

Exemplary embodiment 5 is a method according to one of exemplary embodiments 1 to 4, further comprising generating test data for the generative language model using the at least one augmentation and re-training the generative language model using the generated test data depending on the request similarity measure and depending on a result of testing the generative language model with the test data.

Thus, one or more selected augmentations are also used for training if the testing indicates that further training is required. This may also be done in the context of reinforcement learning, e.g., by using the quality of the result delivered by the generative language model in response to an augmented version (according to a selected augmentation) as a reward. Thus, the method may be used as part of a training process for a generative language model.

According to one embodiment, the embedding model is an embedding model, or a portion of an embedding model, that the generative language model uses for requests provided to it.

This ensures that requests that are similar according to the embedding model (i.e., for which it provides similar embeddings) are also similar from the perspective of the generative language model. However, a different embedding model may also be used, e.g., one that is trained for the same domain as the generative language model (or for the domain, from which the requests come), e.g., embedding of program code. According to one embodiment, the embedding model is at least one embedding model that provides embeddings processed by a component of a generative language model.

The embedding model is not limited to a specific embedding model, but preferably the model is chosen to match the language model. For example, if an application uses an OpenAI GPT model, then an embedding model such as text-embedding-3-large should be selected accordingly. Open models can be used for language models of the Granite family. Further examples are gemini-embedding-exp-03-07 for Google's Gemini models and gte-Qwen2-7B-instruct for Alibaba's Qwen models. Preferably, a language model and embedding model are utilized that are specifically designed for the target domain and its augmentations. Furthermore, a direct comparison model can also be used for comparison in addition to an embedding model.

Exemplary embodiment 6 is a method according to one of exemplary embodiments 1 to 5, wherein the testing is a testing of robustness of the generative language model with respect to the at least one augmentation.

In this way, the generative language model is tested for robustness against plausible augmentations or made robust against such augmentations in subsequent training.

Exemplary embodiment 7 is a method according to exemplary embodiment 6, comprising the data processing system that uses the generative language model declining a request received by such data processing system in response to testing of the robustness of the generative language model indicating that the data processing system cannot provide a robust response to the received request.

This increases the reliability of responding to requests to the data processing system.

Exemplary embodiment 8 is a method according to exemplary embodiments 6 or 7, wherein the testing for robustness is a testing of whether outputs of the generative language model satisfy a specified quality criterion in response to an input of an augmented version of the request generated with the at least one augmentation.

For this purpose, for example, the information is generated per augmented version as to whether the language model is to generate an output that satisfies the quality criterion. In this case, the quality criterion may depend on the original request. For example, in the case of program code, the quality criterion may be that generated program code is error-free or functional (e.g., compilable).

Exemplary embodiment 9 is a method according to exemplary embodiment 8, comprising deriving the at least one augmentation and/or one or more thresholds for the request similarity measure from one or more program code bases for a target task of the program code. This allows plausible and relevant augmentations to be found.

Exemplary embodiment 10 is a method according to exemplary embodiments 1 to 9, wherein the at least one request includes program code and an instruction to the generative language model to revise the program code of the request.

The generative language model that has been tested for robustness against plausible augmentations (e.g., typical programming errors) can generate program code with fewer errors.

Exemplary embodiment 11 is a method according to exemplary embodiment 10, wherein the program code is program code for a control program for a robotic device.

Exemplary embodiment 12 is a method according to exemplary embodiments 1 to 11, comprising, depending on a result of the testing, generating program code using the tested generative language model for a robotic device and controlling the robotic device using the generated program code.

If the testing indicates, for example, that the generative language model (possibly after re-training) is robust against the augmentations, it is used, for example, to revise control code.

Exemplary embodiment 13 is a data processing system for testing a generative language model configured to perform a method according to one of exemplary embodiments 1 to 12.

Exemplary embodiment 14 is a computer program with instructions that, when executed by a processor, cause the processor to carry out a method according to any of exemplary embodiments 1 to 12.

Exemplary embodiment 15 is a computer-readable medium that stores instructions that, when executed by a processor, cause the processor to perform a method according to any of exemplary embodiments 1 to 12.

### BRIEF DESCRIPTION OF THE DRAWINGS

In the drawings, similar reference signs generally refer to the same parts throughout the different views. The drawings are not necessarily to scale, wherein emphasis is instead generally placed on representing the principles of the disclosure. In the following description, various aspects are described with reference to the following drawings.

FIG. 1 shows a computer for developing and/or testing software applications.

FIG. 2 illustrates a plausibility check of an augmentation.

FIG. 3 shows a graph illustrating the categorization of augmentations into plausible and non-plausible augmentations.

FIG. 4 shows a flowchart illustrating a method for testing a generative language model according to one embodiment.

### DETAILED DESCRIPTION

The following detailed description relates to the accompanying drawings, which, for clarification, show specific details and aspects of this disclosure in which the disclosure may be implemented. Other aspects may be used, and structural, logical and electrical changes may be performed without departing from the scope of protection of the disclosure. The various aspects of this disclosure are not necessarily mutually exclusive since some aspects of this disclosure may be combined with one or a plurality of other aspects of this disclosure to form new aspects.

Different examples will be described in more detail in the following.

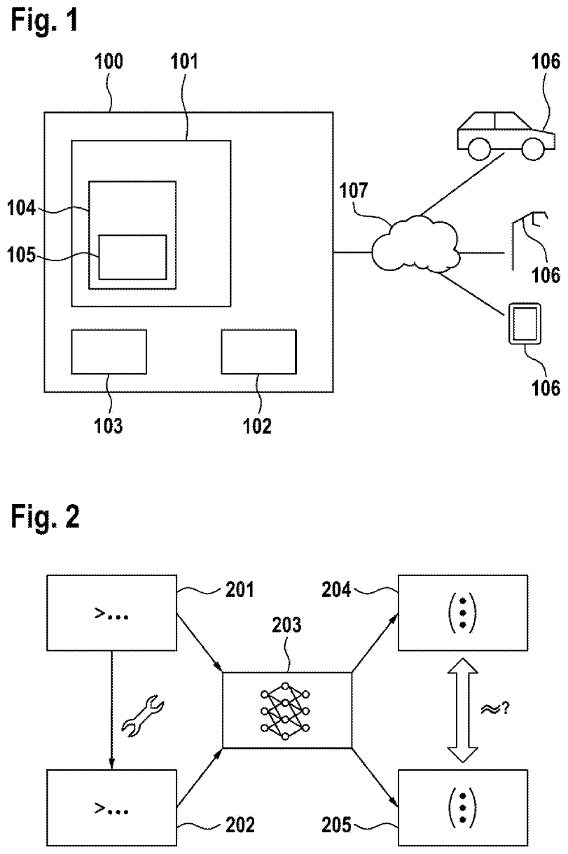

FIG. 1 shows a computer 100 for developing and/or testing software applications.

The computer 100 comprises a CPU (central processing unit) 101 and a working memory (RAM) 102. The working memory 102 is used to load program code, e.g. from a hard drive 103, and the CPU 101 executes the program code.

This example assumes that a user intends to use the computer 100 to develop and/or test a software application.

To do so, the user executes a software development environment 104 on the CPU 101.

The software development environment 104 enables the user to develop and test an application for different devices 106, i.e. target hardware, such as embedded systems for controlling robot devices, including robot arms and autonomous vehicles, or also for mobile (communication) devices. For this purpose the CPU 101 can execute an emulator as part of the software development environment 104 to simulate the behavior of the respective device 106 for which an application is being or has been developed. If it is used only to test software from another source, the software development environment 104 can also be considered or configured as a software test environment.

The user can distribute the finished application to corresponding devices 106 via a communication network 107. Instead of a communication network 107, this can also be done in other ways, for example using a USB stick.

Before this happens, however, the user should test the application in order to avoid distributing an improperly functioning application to the devices 106.

In a scenario as shown in FIG. 1, a generative language model 105 may be involved in a variety of ways: The application itself may be a generative language model that, after its development (in particular its training), may be used for various purposes (in particular technical purposes), for example, to complete knowledge graphs for controlling robots, translating voice commands into control signals (i.e., into a format understandable by a robot) in real time, evaluating error logs (diagnosis) of a technical system, or generating traffic situations to train or test a control strategy for an autonomous vehicle.

On the other hand, the generative language model 105 itself may also be part of the software development environment 104 in the sense that it is used for code generation. For example, a prompt may be provided to it that describes the purpose of a program and the task of generating such a program in a particular programming language and/or for a particular target device 106. It can also perform tasks on existing program code using appropriate prompts. For example, it may improve program code (e.g., fix bugs), or it may translate program code from one programming language to another.

In any case, i.e., regardless of whether the generative language model 105 itself corresponds to the developed application or whether it is used to develop an application (i.e., at least partially generates it itself), the generative language model 105 should be tested, particularly with regard to the purpose, for which it is to be used.

For example, a generative language model 105 (e.g., a large language model) may provide results that are not correct or do not meet desired quality criteria (such results are also referred to as hallucinations). A self-assessment by an LLM regarding its confidence is typically not trustworthy.

According to various embodiments, an approach is provided that enables effective testing of a generative language model 105 with respect to the purpose, for which it is employed. In the following paragraphs, the processing of program code is described as an example, i.e., the program is intended to process existing program code (e.g., detect and correct errors), e.g., for the development of an application as described with reference to FIG. 1.

The prompts (i.e., the requests to the generative language model 105) thus already contain program code that the generative language model 105 is to process. In addition, in the following examples, for simplicity, it is assumed that the generative language model is an LLM.

The goal of testing the generative language model 105 can be seen in particular as assessing whether the generative language model 105 can provide correct responses, i.e., in the present example, program code that satisfies a certain quality criterion, e.g., that fulfills a specified purpose without errors.

Test data may be generated from existing requests (prompts) through augmentations. An augmentation is a modification of a request to replicate existing requests with relevant modifications, e.g., rotation or cropping in images and variable renaming or formatting in code. A specific technique, such as a particular variable renaming, is also referred to as a perturbation.

According to various embodiments, augmentations are used to test the LLM 105, taking into account domain knowledge. Specifically, domain-specific augmentation of existing LLM requests (so-called test-time augmentation) is used, i.e., augmentations that are typical of the intended use of the LLM 105. In the present example of program code improvement, these could be, for example, typos such as those programmers typically make. An existing request (i.e., in particular, existing program code) is provided, for example, with a typical typo in order to feed it to the LLM 105 for testing. Which augmentations are typical in this sense can be determined, for example, from a code base available to a software development company, e.g., program code created by programmers of the software development company in the last few years (e.g., variations contained therein, e.g., in terms of identifiers, implementation styles, or optimizations).

The LLM 105 can then be tested to determine whether it successfully processes requests that have been altered with such augmentations, i.e., whether the LLM 105 is robust against such augmentations. Thus, according to various embodiments, augmentations are selected to generate test data for testing the LLM 105, wherein it is tested whether the LLM 105 processes the generated test data such that its output satisfies a quality criterion (for example, generating functional program code from program code augmented according to a selected augmentation).

A decision of whether to use an augmentation to generate test data from an existing request is made based on an embedding of the request altered with the augmentation (i.e., an augmentation for an existing request is checked for plausibility based on an embedding of the augmented request). Embedding here is understood to mean an embedding, in other words an encoding, as generated by a generative language model from a request in order to further process the request.

Embeddings are numeric vectors that are used to represent information. Generative language models (in particular LLMs) use such embeddings internally to represent sequences of tokens. Comparisons between the distances of these embeddings make it possible to determine whether a generative language model interprets two sequences of tokens as being similar or rather as not being similar.

A generative language model typically generates its response to a request token by token by appending the next token based on the previous tokens and a self-determined confidence that strongly depends on the training basis (called token prediction). Metrics regarding confidences of token predictions can be returned, but they are typically not meaningful. That is to say, just because each token is followed by only one token with high confidence in an output (and all other tokens each have low confidence), the output is not necessarily particularly correct. Conversely, just because each token is followed by multiple tokens with similarly low confidence in an output, the output is not necessarily particularly incorrect.

For example, to decide whether an augmented request (i.e., an augmented version of the request) is used, the procedure illustrated in FIG. 2 is followed.

FIG. 2 illustrates a plausibility check of an augmentation.

For an (original) request 201, an augmented version 202 of the request is determined by augmentation. Using an embedding model 203, a respective embedding 204, 205 is then determined in each case (this can also be done only for a substantial part of the request, e.g., the program code that is to be processed). The embedding model 203 may be the embedding model of the LLM 105 to be tested, but may also be that of another generative language model that processes similar inputs (i.e., can also process program code, for example). An (embedding) similarity measure, e.g., from the value of a distance metric (e.g., as its reciprocal) or, e.g., cosine similarity, is then determined in the respective embedding space between these embeddings 204, 205 (which is typically a space of high-dimensional vectors). This similarity measure of the embeddings can then also be used as a similarity measure of the two requests 201, 202.

A general model such as a cross-encoder may also be used, which internally calculates embeddings from two texts (i.e., in the present case, from requests or at least parts thereof, e.g., program code) and directly outputs a 0-1 rating indicating how similar or different the texts are, i.e., providing a similarity measure.

If the augmented version of a request is dissimilar to the request (high distance in the embedding space), augmentation is not interesting for that request and is not used to generate test data (from that request). This follows the logic that, if the augmented version of a request is dissimilar to the request, it is not plausible that it occurs. For example, it is not plausible that program code corresponding to such augmentation of correct code (e.g., that a completely incorrect function was used) occurs, and therefore the LLM 105 does not necessarily need to be robust against this augmentation.

On the other hand, if the augmented version of a request is similar to the request (low distance in the embedding space), augmentation is interesting for that request and is used to generate test data (from that request). If the augmented version of a request is similar to the request, it is plausible that it occurs, and the LLM 105 should be robust against this augmentation; that is, from the perspective of the embedding model, the augmented version of the request is similar enough to the original request to enable a successful response to the request.

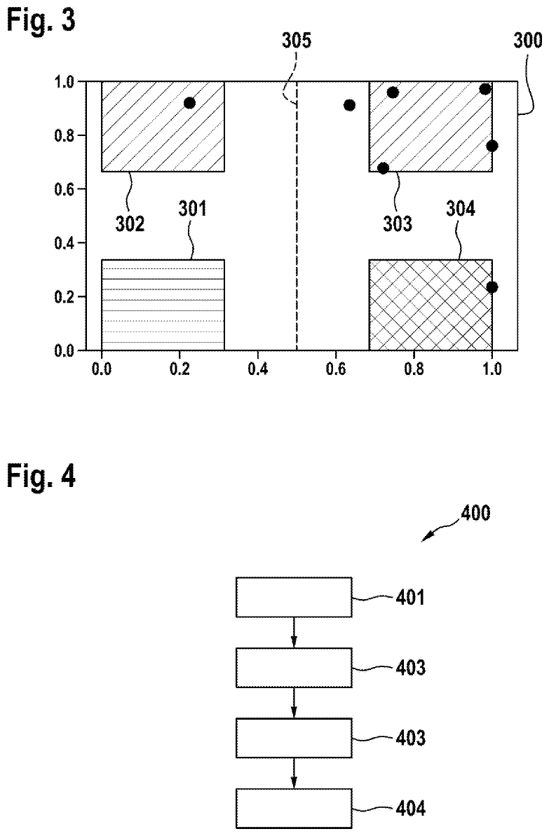

FIG. 3 shows a graph 300 illustrating the categorization of augmentations (for a given request) into plausible and non-plausible augmentations. Augmentations are represented by dots. The similarity of the request augmented with a respective augmentation to the request increases from left to right (cosine similarity in this case), and how well the quality criterion is satisfied by the output of the LLM 105 for the augmented request (e.g., compilability of output program code) increases from top to bottom.

Four areas are labeled:

Area 301 at lower left: low similarity, low output quality. An augmentation in this area is not selected because the similarity is low. The model would potentially not be robust at this point, but the specific augmentation is outside the area to be tested.

Area 302 at upper left: low similarity, high output quality. An augmentation in this area is not selected because the similarity is low. The model would potentially even be robust at this point, although the specific augmentation is outside the area to be tested.

Area 303 at upper right: high similarity, high output quality. An augmentation in this area is selected. If it is in this area, this indicates no problem with the LLM 105 being tested, because the output quality is high.

Area 304 at lower right: high similarity, low output quality. An augmentation in this area is selected. If it is in this area, this indicates a problem with the LLM 105 being tested, because the output quality is low, but the augmentation is plausible.

The threshold 305 for the similarity, starting at which an augmentation is used, may be determined experimentally for the respective application.

It should be noted that generative language models typically have a random component (the output depends on the value of a seed). The shown positions of the augmentations can therefore be generated by averaging the respective outputs or embedding similarity measures over multiple processing runs (passes) through the LLM 105. For example, an augmented request may result in output satisfying the quality criterion nine times, and once not. Likewise, the embedding distance between the augmented version of the request and the original request may vary from run to run. Thus, the similarity measure between augmented versions of a request generated by an augmentation and the original version of the request may be an average of embedding similarity measures (for different embeddings generated by multiple applications of the embedding model). The similarity measure between augmented versions of a request generated by an augmentation and the original version of the request may also be generated by averaging multiple augmented versions: Using the (same) augmentation, multiple augmented versions are generated (since the augmentation may also have a random component, e.g., which variables are exchanged). Then, for each augmented version, a similarity measure with respect to the original request is determined (from the similarity of the respective embeddings, wherein, as explained above, multiple embeddings of the augmented version may be averaged), and these similarity measures are then averaged to obtain the request similarity measure for the augmentation. Averaging to determine the request similarity measure for the augmentation can thus, in particular, consist of two steps: First, for each augmented version generated, the embedding similarity measures of the embeddings are averaged, and then the result is averaged over the augmented versions.

As described above, augmentations are selected (if applicable, individually for each request) according to various embodiments to generate test data for an LLM 105 (generally, a generative language model) from existing requests. These may then be used, for example, in connection with testing the LLM 105 (e.g., by the software development environment 104):

1) Robust evaluation of LLMs: Requiring or ensuring a certain consistency measure or quality criterion with regard to the outputs that the LLM provides for versions augmented by selected augmentations of an existing LLM request.
2) Data selection for improvement (in particular, training) of an LLM (e.g., if it does not yet satisfy a test criterion): Identifying data points of interest (test data), since consistency of outputs for augmented requests (a set of requests) is more difficult to achieve than for arbitrary data points.
3) Fine-tuning of the LLM, e.g., via reinforcement learning: Automatically assessing and improving the LLM based on all data points seen during use of an LLM. For example, requests are generated using selected augmentations, feedback is provided on the results delivered by the LLM for these generated requests (by comparison with a desired result), and the LLM is adjusted so that it is more likely to deliver results with good feedback.

An exemplary embodiment is described below. The domain here is program code, but the described approach can be applied to any domain with corresponding domain-specific perturbations.

For example, when a single LLM is considered, it is examined whether the LLM is robust. If many LLMs (i.e., an ensemble of similarly good models) are considered in parallel, on the other hand, the focus can be placed on the data (data robustness): When a single model is considered, the errors of the specific model are examined. If many models are considered, then the error is consistent across many models, and it can be assumed that it arises from the data because no model can handle it. This thus provides information about the robustness of the data (e.g., of requests) rather than about the robustness of a model.

It should be noted that a generative language model such as an LLM always includes a tokenizer. The tokenizer may be sensitive to specific perturbations, e.g., because the text is split based on capitalization prior to the actual tokenization.

In the example presented at the end of this description but before the claims, the present request is a processing of a simple program function for an embedded system that alters certain bits. This function is referred to below as Snippet 1.

Perturbations of this function follow. The first perturbation is referred to as Snippet 2: Only the formatting of the code has been changed to the Mozilla standard. Note that, on the one hand, the Mozilla standard allows fewer characters per line; on the other hand, it allows function arguments on the same line.

The second perturbation is referred to as Snippet 3: Starting from Snippet 1, all variable identifiers were replaced with the shortest possible identifiers. For example, the local variable bitNum is now called a.

Snippet 4 is another function from the same program version.

Snippet 5 is a further perturbation that merely adds a detailed comment.

It is expected that the embeddings of Snippets 1, 2, 3, and 5 are very similar, while the embedding of Snippet 4 is significantly less similar.

With an LLM (e.g., the LLM Snowflake/snowflake-arctic-embed-m-v1.5), the following values result for the pairwise cosine similarity between the individual snippets, which exactly meet these expectations.

TABLE 1

| | Snippet 1 | Snippet 2 | Snippet 3 | Snippet 4 | Snippet 5 |
|---|---|---|---|---|---|
| Snippet 1 | 1. | 0.99924441 | 0.97190644 | 0.66233298 | 0.96073365 |
| Snippet 2 | 0.99924441 | 1. | 0.96998599 | 0.66130938 | 0.95968659 |
| Snippet 3 | 0.97190644 | 0.96998599 | 1. | 0.65927075 | 0.94691491 |
| Snippet 4 | 0.66233298 | 0.66130938 | 0.65927075 | 1. | 0.67747695 |
| Snippet 5 | 0.96073365 | 0.95968659 | 0.94691491 | 0.67747695 | 1. |

In the application for program code, the program code does not necessarily need to be provided to the LLM 105 in text form, but can also, for example, be provided to the LLM 105 encoded as an abstract syntax tree (AST). In this case, it is exploited and shown even more explicitly that the program code does not contain any ambiguities (as opposed to natural language). With the AST representation, it becomes even clearer that program code is the input (and not natural language), and one can normalize certain nodes of the AST for, for example, variable names or comments.

Other possible perturbations, in addition to replacing variable names and formatting program code differently, may include, for example, the following: (i) introducing typographical errors with a certain probability; (ii) translating natural-language text into another language; (iii) in addition, the text portion from the previous item can then be translated back into the original language; (iv) removing or modifying any comments in the program code, (v) using different capitalization for variables in the code; and (vi) (logical) rewordings (behavior-neutral) within the program code.

Further augmentations are possible, and the perturbations mentioned herein are to be understood as examples only. The last item in the above list goes beyond the previous purely syntactic perturbations with logical perturbations.

For example, the program code processed by the LLM 105 may implement functionality on a control unit (ECU). Examples include control units for an engine, an airbag, a windshield wiper, etc., which interact with the environment via sensors and actuators. Similarly, applications in robotics are possible, e.g., for lawn-mowing robots or transport robots in a factory.

In summary, according to various embodiments, a method as shown in FIG. 4 is provided.

FIG. 4 shows a flowchart 400 illustrating a method for testing a generative language model according to one embodiment.

For at least one request to the generative language model, for at least one augmentation, at least one augmented version of the request is generated using the augmentation in step 401. To this end, the desired result (i.e., output) provided by the language model may also be generated for the respective augmented version of the request. In many cases, this may be invariant (output remains the same), but this need not be the case.

In step 402, the at least one augmented version of the request and the request are embedded into an embedding space using a machine embedding model (i.e., generating an embedding, typically in the form of a vector).

In step 403, for the at least one augmentation, a request similarity measure is determined between the at least one augmented version of the request and the request from a measure of similarity of the embedded at least one augmented version of the request to the embedded request in the embedding space.

In step 404, test data for the generative language model using the at least one augmentation is generated, and the generative language model is tested using the generated test data depending on the request similarity measure.

The method according to FIG. 4 may be performed by one or a plurality of computers comprising one or a plurality of data processing units. The term “data processing unit” may be understood to mean any type of entity that enables the processing of data or signals. The data or signals may, for example, be processed according to at least one (i.e., one or more than one) specific function performed by the data processing unit. A data processing unit may comprise or be formed from an analog circuit, a digital circuit, a logic circuit, a microprocessor, a microcontroller, a central processing unit (CPU), a graphics processing unit (GPU), a digital signal processor (DSP), an integrated circuit of a programmable gate array (FPGA) or any combination thereof. Any other way of implementing the respective functions described in more detail here may also be understood as a data processing unit or logic circuit array. One or a plurality of the method steps described in detail here may be carried out (e.g., implemented) by a data processing unit by means of one or a plurality of specific functions performed by the data processing unit.

According to various embodiments, the method is thus, in particular, computer-implemented.

For example, the generative language model (after testing and, if applicable, re-training) is used to generate a control program for a robotic device. The term “robotic device” can be understood as relating to any technical system (with a mechanical part whose movement is controlled), such as a computer-controlled machine, a vehicle, a household appliance, an electric tool, a manufacturing machine, a personal assistant, or an access control system.

```
Snippet 1:
  #include <stdint.h>
  typedef uint8_t uint8;
  typedef uint32_t uint32;
  uint32
  getHighestBit(
  const uint8 *op,
  const uint32 opLength)
  {
  uint32 bitNum;
  uint8 mask;
  uint32 i;
  bitNum = 0U;
  /* Find the first byte that is not equal to zero; increase the bit index by 8 for
  each byte found */
  for (i = 0U; ((i < (opLength − 1U)) && (op[i] == 0U)); i++)
  {
  bitNum += 8U;
  }
  /* In the first nonzero byte, find the first bit that is equal to one */
  for (mask = (uint8) 0x80U; (((op[i] & mask) == 0U) && (mask > 0U));
  mask >>= 1U)
  {
  bitNum++;
  }
  return bitNum;
  }
Snippet 2:
  #include <stdint.h>
  typedef uint8_t uint8;
  typedef uint32_t uint32;
  uint32
  getHighestBit(const uint8* op, const uint32 opLength)
  {
  uint32 bitNum;
  uint8 mask;
  uint32 i;
  bitNum = 0U;
  /* Find the first byte that is not equal to zero; increase the bit index by 8 for
  each byte found */
  for (i = 0U; ((i < (opLength − 1U)) && (op[i] == 0U)); i++) {
  bitNum += 8U;
  }
  /* In the first nonzero byte, find the first bit that is equal to one */
  for (mask = (uint8)0x80U; (((op[i] & mask) == 0U) && (mask > 0U));
  mask >>= 1U) {
  bitNum++;
  }
  return bitNum;
  }
Snippet 3:
  #include <stdint.h>
  typedef uint8_t uint8;
  typedef uint32_t uint32;
  uint32
  f(
  const uint8 *d,
  const uint32 e)
  {
  uint32 a;
  uint8 b;
  uint32 c;
  a = 0U;
  /* Find the first byte that is not equal to zero; increase the bit index by 8 for
  each byte found */
  for (c = 0U; ((c < (e − 1U)) && (d[c] == 0U)); c++)
  {
  a += 8U;
  }
  /* In the first byte that is not equal to zero, find the first bit that is equal to
  one */
  for (b = (uint8) 0x80U; (((d[c] & b) == 0U) && (b > 0U)); b >>= 1U)
  {
  a++;
  }
  return a;
  }
Snippet 4:
  #define TRUE ((boolean) 1U)
  #define RESPONSELENGTH_UNSUPPORTEDSERVICE 5u
  #define STATUS_NOT_SUPPORTED 1u
  #define SERVICEIDLENGTH 4u
  #include <stdint.h>
  typedef uint8_t uint8;
  typedef uint8 boolean;
  static boolean ServiceDispatcher_UnsupportedServiceId(uint8* payload_p,
  uint8* payloadLength_p)
  {
  /* To generate a response, the same Rx buffer is used. The first 4 bytes are
  already occupied by the service ID. */
  uint8 dataIndex = SERVICEIDLENGTH;
  uint8 status = STATUS_NOT_SUPPORTED;
  *payloadLength_p = RESPONSELENGTH_UNSUPPORTEDSERVICE;
  /* create response data */
  payload_p[dataIndex] = status;
  return TRUE;
  }
Snippet 5:
  #include <stdint.h>
  typedef uint8_t uint8;
  typedef uint32_t uint32;
  uint32
  getHighestBit(
  const uint8 *op,
  const uint32 opLength)
  /*Lorem ipsum dolor sit amet, consectetur adipiscing elit, sed do eiusmod
  tempor incididunt ut labore et dolore magna aliqua.
  Ut enim ad minim veniam, quis nostrud exercitation ullamco laboris nisi ut
  aliquip ex ea commodo consequat.
  Duis aute irure dolor in reprehenderit in voluptate velit esse cillum dolore
  eu fugiat nulla pariatur.
  Excepteur sint occaecat cupidatat non proident, sunt in culpa qui officia
  deserunt mollit anim id est laborum.*/
  {
  uint32 bitNum;
  uint8 mask;
  uint32 i;
  bitNum = 0U;
  /* Find the first byte that is not equal to zero; increase the bit index by 8 for
  each byte found */
  for (i = 0U; ((i < (opLength − 1U)) && (op[i] == 0U)); i++)
  {
  bitNum += 8U;
  }
  /* In the first byte that is not equal to zero, find the first bit that is equal to
  one */
  for (mask = (uint8) 0x80U; (((op[i] & mask) == 0U) && (mask > 0U));
  mask >>= 1U)
  {
  bitNum++;
  }
  return bitNum;
  }
```

What is claimed is:

1. A method for testing a generative language model using test data, the method comprising:
for at least one request to the generative language model, generating, for at least one augmentation, at least one augmented version of the at least one request using the at least one augmentation;
embedding the at least one augmented version of the at least one request and the at least one request into an embedding space using a machine embedding model;
determining, for the at least one augmentation, a request similarity measure between the at least one augmented version of the at least one request and the at least one request from a measure of similarity of the embedded at least one augmented version of the at least one request to the embedded request in the embedding space;
generating the test data for the generative language model using the at least one augmentation; and
testing the generative language model using the test data depending on the request similarity measure.

2. The method according to claim 1, further comprising:
generating a plurality of augmented versions of the at least one request, including the at least one augmented version, using the at least one augmentation;
generating, for each augmented version of the plurality of augmented versions of the at least one request, at least one embedding of the augmented version of the at least one request into the embedding space and generating an embedding of the at least one request;
determining, for each embedding of the augmented version, an embedding similarity measure between the at least one embedding of the augmented version of the at least one request and the embedding of the at least one request; and
determining the request similarity measure by aggregating the embedding similarity measures across the augmented versions of the at least one request.

3. The method according to claim 1, further comprising:
testing the generative language model using the test data in response to the request similarity measure exceeding a specified threshold.

4. The method according to claim 1, further comprising:
generating, for each of a plurality of augmentations, at least one augmented version of the at least one request using the at least one augmentation;
embedding the at least one augmented version of the at least one request and the at least one request into the embedding space using the machine embedding model;
determining, for the at least one augmentation, the request similarity measure between the at least one augmented version of the at least one request and the at least one request from the measure of similarity of the embedded at least one augmented version of the at least one request to the embedded request in the embedding space;
selecting, from the plurality of augmentations, one or more augmentations, for which highest request similarity measures have been determined; and
testing the generative language model using the test data.

5. The method according to claim 1, further comprising:
re-training the generative language model using the test data depending on the request similarity measure and depending on a result of testing the generative language model with the test data.

6. The method according to claim 1, wherein the testing is a testing of robustness of the generative language model with respect to the at least one augmentation.

7. The method according to claim 6, further comprising:
a data processing system that uses the generative language model declining a received request received by such data processing system in response to the testing of the robustness of the generative language model indicating that the data processing system cannot provide a robust response to the received request.

8. The method according to claim 6, wherein the testing for the robustness is a testing of whether outputs of the generative language model satisfy a specified quality criterion in response to an input of the at least one augmented version of the at least one request generated with the at least one augmentation.

9. The method according to claim 1, wherein the at least one request includes a program code and an instruction to the generative language model to revise the program code of the at least one request.

10. The method according to claim 9, comprising:
deriving the at least one augmentation and/or one or more thresholds for the request similarity measure from one or more program code bases for a target task of the program code.

11. The method according to claim 9, wherein the program code is program code for a control program for a robotic device.

12. The method according to claim 1, further comprising:
depending on a result of the testing, generating a program code using the generative language model for a robotic device and controlling the robotic device using the program code.

13. A data processing system for testing a generative language model, comprising:
a processor configured to carry out the method according to claim 1.

14. The method according to claim 1, wherein a computer program includes instructions that, when executed by a processor, cause the processor to carry out the method.

15. A nontransitory computer-readable medium that stores instructions that, when executed by a processor, cause the processor to carry out the method according to claim 1.
